(19) United States
(12) Patent Application Publication
(10) Pub. No.: US 2007/0158500 A1
(43) Pub. Date: Jul. 12, 2007

(54) Solid oxide fuel cell system for aircraft power, heat, water, and oxygen generation

(75) Inventors: K.R. Sridhar, Los Gatos, CA (US); James Frederick McElroy, Suffield, CT (US)

Correspondence Address: FOLEY AND LARDNER LLP;SUITE 500, 3000 K STREET NW, WASHINGTON, DC, 20007, US

(73) Assignee: ION AMERICA CORPORATION

(21) Appl. No.: 11/326,400

(22) Filed: Jan. 6, 2006

(51) Int. Cl. B64D 11/00

(52) U.S. Cl. 244/118.5

(57) ABSTRACT

An aircraft contains a plurality of solid oxide fuel cells located in different portions of the aircraft. A method of operating the plurality of solid oxide fuel cells includes providing power from each of the plurality of solid oxide fuel cells to at least one of a plurality of power consuming components located in a same portion of the aircraft as the solid oxide fuel cell. Another method of operating at least one solid oxide fuel cell located in an aircraft includes providing ambient air and power to the solid oxide fuel cell without providing fuel to the solid oxide fuel cell to generate oxygen for the aircraft cabin when the aircraft is in flight. Another method of operating at least one solid oxide fuel cell located in a passenger aircraft includes providing water from the solid oxide fuel cell to the aircraft cabin.

### BACKGROUND OF THE INVENTION

The invention generally relates to the fuel cells, and specifically to use of a solid oxide fuel cell system in an aircraft.

A solid oxide fuel cell (SOFC) is an electrochemical device that converts chemical energy directly into electrical energy using a solid oxide (i.e., ceramic) electrolyte. A solid oxide reversible fuel cell (SORFC) is an electrochemical device that converts chemical energy directly into electrical energy and subsequently reconverts electrical energy back to chemical energy.

The efficiency of transporting humans in aircraft is closely related to the mass of equipment and expendables per human passenger. There are efficiency improvements when the aircraft is increased in size and additional passengers are transported. At some size, a practical limit is reached and increased efficiency is only obtained by a fractional percentage engine efficiency improvement, squeezing additional passengers into a fixed space, a mass reduction of the on-board carried food, or similar incremental equivalent mass reductions per passenger carried.

### BRIEF SUMMARY OF THE INVENTION

In one aspect of the present invention an aircraft contains a plurality of solid oxide fuel cells located in different portions of the aircraft. A method of operating the plurality of solid oxide fuel cells includes providing power from each of the plurality of solid oxide fuel cells to at least one of a plurality of power consuming components located in a same portion of the aircraft as the solid oxide fuel cell.

In another aspect of the present invention, a method of operating at least one solid oxide fuel cell located in an aircraft includes providing ambient air and power to the solid oxide fuel cell without providing fuel to the solid oxide fuel cell to generate oxygen for the aircraft cabin when the aircraft is in flight.

### BRIEF DESCRIPTION OF THE DRAWINGS

FIG. 1 is a schematic side cross sectional view of an aircraft according to the first embodiment of the invention.

FIG. 2 is a schematic side cross sectional view of an aircraft according to the second embodiment of the invention.

### DETAILED DESCRIPTION OF THE PREFERRED EMBODIMENTS

The present inventors have realized that a solid oxide fuel cell system can combine the functions of many required aircraft systems and in the process can reduce the mass of the loaded aircraft and therefore increase the overall aircraft efficiency. The SOFCs may provide the electrical power needs of the aircraft both on the ground and/or in flight. On the ground, the SOFCs provide quiet and clean power to the aircraft. Noise and pollution are big airport operator concerns with the prior art equipment generally used to provide ground electrical power. In flight, the SOFCs may provide the electrical power to the aircraft at a much higher efficiency then the current method of running an electric generator off the propulsion gas turbine. This saves fuel and reduces takeoff mass and increases aircraft efficiency.

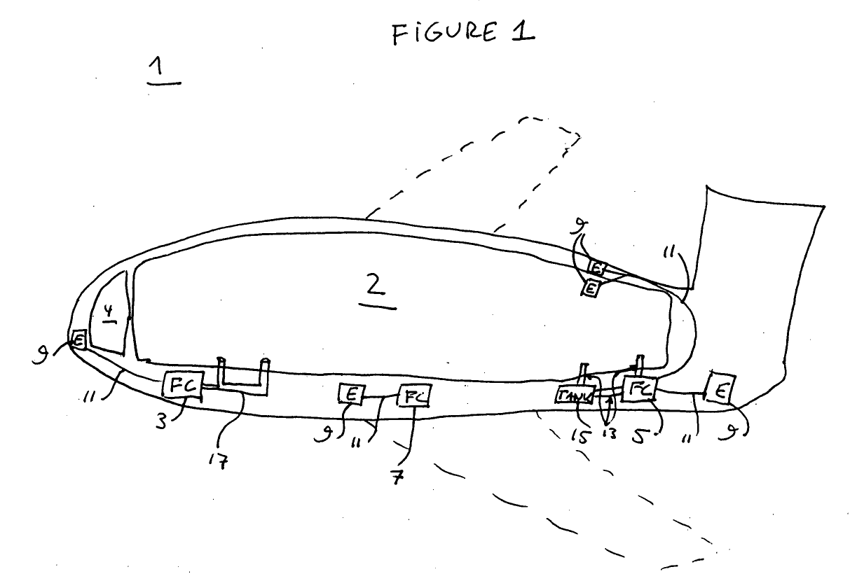

In the first embodiment, the aircraft contains a plurality of solid oxide fuel cells located in different portions of the aircraft. Preferably, the aircraft comprises a passenger airplane, such as a large passenger airplane which holds 100 or more passengers, for example. However, other types of aircraft may also be suitable. As shown in FIG. 1, aircraft 1 contains a first solid oxide fuel cell 3 located in a front part of the aircraft and a second solid oxide fuel cell 5 located in a rear part of the aircraft. Front and rear parts are located on opposite parts of the aircraft body center line. If desired, a third solid oxide fuel cell 7 is located in a middle part of the aircraft 1. Preferably, the solid oxide fuel cells are distributed throughout the aircraft 1. Thus, the aircraft 1 may contain more than three locations containing the fuel cells and/or each part or section of the aircraft may contain more than one fuel cell location. Thus, the fuel cells may be distributed in different locations in one or more sections of the aircraft rather than being clustered in one location.

While FIG. 1 schematically illustrates solid oxide fuel cells, these solid oxide fuel cells are preferably arranged in a plurality of solid oxide fuel cell stacks which are distributed throughout the aircraft. Thus, separate stacks of solid oxide fuel cells (which are also denoted by numbers 3, 5 and 7 in FIG. 1 for simplicity) are preferably located in separate locations in the aircraft 1. The SOFC stacks may be located below and/or above the cabin (which includes at least one of the passenger section 2 and the cockpit section 4), in the nose, tail and/or wing sections of the aircraft.

The fact that the SOFC's are distributed throughout the aircraft significantly reduces the power conductor, such as copper, mass and increases aircraft efficiency. The aircraft 1 contains a plurality of power consuming components 9 located in different portions of the aircraft. For example, as shown in FIG. 1, the components 9 are distributed throughout the aircraft 1. FIG. 1 shows that the power conductor 11 length from the SOFCs 3, 5, 7 to the power consuming components 9 of the aircraft is reduced due to the SOFC distribution. The power consuming components may comprise aircraft electronics and components, such as the lighting, temperature control or flight control electronics and components, for example. The power consuming components 9 may be located in or on the wing or tail sections of the aircraft, or in, above, below, behind, ahead and/or on the side of the cabin. The power from each of the SOFCs 3, 5, 7 located in a different part of the aircraft is provided through a respective power conductor 11 to a respective one or more of the power consuming components 9 located in a same portion of the aircraft as the SOFC. In other words, each one of the plurality of the solid oxide fuel cell stacks 3, 5, 7 provides power to at least one of the plurality of the power consuming components 9 which is located in the same portion or section of the aircraft as the respective solid oxide fuel cell stack. For example, each one of the plurality of the solid oxide fuel cell stacks 3, 5, 7 may provide power to at least one of the plurality of the power consuming components 9 which is located adjacent to the respective solid oxide fuel cell stack.

Other optional mass reducing aircraft configurations include eliminating or downsizing other equipment such as heat generators and/or water storage, as the SOFCs generate these items as a free byproduct. Specifically, the SOFCs can operate on a hydrogen or a hydrocarbon (including natural gas, pure methane, pentane or jet fuel, such as Jet A, Jet A-1, Jet B, JP-8, etc.) fuel. Thus, if desired, the SOFCs can operate on the same jet fuel as the aircraft engines, which allows a separate fuel source for the SOFCs to be omitted. The fuel combines at the SOFC anode electrode with oxygen transmitted from the SOFC cathode electrode through the electrolyte to form water, heat and optionally other by-products if a hydrocarbon fuel is used.

Thus, the aircraft 1 may further comprise one or more optional water transport conduits 13 which are configured to provide water from the solid oxide fuel cells to the aircraft cabin. While only one conduit 13 connected to one SOFC or SOFC stack 3 is shown in FIG. 1 for clarity, there may be plural conduits 13. For example, each SOFC stack may have a separate water transport conduit. Alternatively, a single conduit 13 may be connected to plural SOFC stacks. The water transport conduit may comprise any suitable conduit, such as a pipe or duct which collects water provided from the fuel cell anode electrodes and provides the water directly or indirectly to the cabin. For example, the water may be provided to the faucets and/or lavatories in the cabin directly. Alternatively, the water may be first provided to a water storage tank 15 from which it is then provided to the faucets and/or lavatories in the cabin. Since water is generated by the fuel cells, the size of the water tank 15 may be reduced compared to those in the prior art aircraft and/or the aircraft may take off with less water in the water tank than in the prior art. Thus, a method of operating at least one solid oxide fuel cell (i.e., including one or more solid oxide fuel cell stacks) located in a passenger aircraft includes providing water from the solid oxide fuel cell to the aircraft cabin.

The aircraft 1 may further comprise one or more optional heat transport conduits 17 which are configured to provide heat from the solid oxide fuel cells to the aircraft cabin. While only one conduit 17 connected to one SOFC or SOFC stack 3 is shown in FIG. 1 for clarity, there may be plural conduits 17. For example, each SOFC stack may have a separate heat transport conduit. Alternatively, a single conduit 17 may be connected to plural SOFC stacks. The aircraft may have one, none or both types of the transport conduits 13, 17.

The SOFC generates heat during operation. The heat transport conduit 17 transports heat from the SOFCs to the cabin, equipment (i.e., electronics, etc.) or other payload in need of heat. The heat transport conduit 17 may comprise pipe(s) or duct(s) filled with a heat transfer medium, such as a gas or liquid. Preferably, the conduit 17 uses air as the heat transfer medium. Cooling air is blown past or adjacent to the hot fuel cell stack through the conduit. The air absorbs heat as it is passed through the conduit and the warmed air is guided toward or adjacent to the remotely located cabin, equipment or other payload that needs to be heated. Thus, the conduit 17 provides heat to cabin, equipment or payload that would not ordinarily be heated by the SOFCs. The conduit 17 may be an open or a closed loop. The heat transport conduit can also operate with a liquid or a two-phase re-circulation loop. Other modes of heat transfer, such as conduction or radiation can also be used.

In a second embodiment of the invention, a method of operating at least one solid oxide fuel cell located in an aircraft includes providing ambient air and power to the solid oxide fuel cell without providing fuel (such as hydrogen or hydrocarbon fuel) to the solid oxide fuel cell to generate oxygen for the aircraft cabin when the aircraft is in flight. In the second embodiment, the aircraft may have all of the fuel cells in one location or the fuel cells may be distributed throughout the aircraft 1, as described with respect to the first embodiment above. Thus, the aircraft 1 may contain one or more SOFC stacks located only in one part of the aircraft or the aircraft may have the SOFC stacks distributed throughout the aircraft.

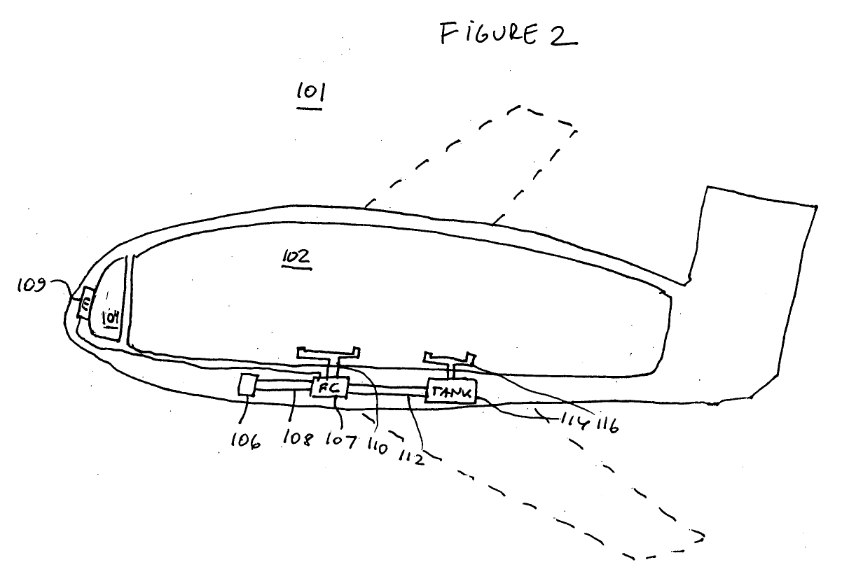

As shown in FIG. 2, the aircraft 101 contains a cabin containing at least one of a passenger section 102 and a cockpit section 104. The aircraft also contains one or more air intake openings 106. The opening 106 is connected to a SOFC stack 107 via a conduit 108. There may be one opening 106 connected to plural SOFCs or SOFC stacks via conduit(s) 108 or there may be a plurality of openings 106 connected to respective SOFCs or SOFC stacks via one or more conduits 108. Ambient air is provided to the cathode electrodes of the SOFCs in the stack 107 from the conduit 108. A voltage is provided to the SOFC stack 107 from any suitable voltage source, such as a battery, other SOFC stack(s) and/or from the electric generator connected to the propulsion gas turbine(s). The voltage causes the oxygen present in the ambient air to be transmitted through the SOFC electrolytes to the SOFC anode electrodes. The pure oxygen is collected at the anode electrodes of the SOFCs and is then provided directly and/or indirectly to the cabin. For example, the oxygen may optionally be mixed with stored or ambient air and then be directly provided to the cabin through conduit 110. Alternatively or in combination, the oxygen may be provided through conduit 112 to a storage vessel 114, such as an air or oxygen tank, to be stored. The oxygen or air may be mixed with air in tank 114. The oxygen or air is then provided from vessel 114 to the cabin through conduit 116. It should be noted that conduits 110 and/or 116 may provide oxygen into the cabin from the floor, wall(s) and/or the ceiling of the cabin. The conduits 110 and/or 116 may also be connected to the emergency oxygen supply system which provides oxygen or air into the emergency air masks.

Taking the ambient air at ambient pressure and without compression, a pure metabolic oxygen gas is electrochemically produced using the SOFCs. Using this oxygen for metabolic use allows the air circulation to be reduced and/or the amount of cabin pressurization to be reduced. By allowing the oxygen content in air to increase to a range of about 22% to about 25% and reducing the total pressure to establish the current oxygen partial pressure standard, a great reduction in structural mass of the aircraft can be realized along with significant aircraft efficiency gains.

Preferably, the SOFC contains reversible electrodes for oxygen generation, even if the SOFC is not operated reversibly, since the anode electrodes will be exposed to an oxidizing environment in the oxygen generation mode. The reversible electrodes may comprise, for example, any suitable materials found in solid oxide reversible fuel cells. In non-regenerative solid oxide fuel cells, nickel-YSZ mixtures are commonly used as anode (i.e., fuel) electrodes. Nickel requires a reducing environment in order to work properly. Thus, materials capable of conducting electrons in an oxidizing environment should be used as the anode electrode. For example, platinum that is mixed with YSZ or LSM can be used as the anode electrode material. Other materials that are capable of conducting electrons in an oxidizing environment can also be used.

The SOFC also contains a solid oxide (i.e., ceramic) electrolyte, such as yttria stabilized zirconia (YSZ) or scandia stabilized zirconia (SSZ). The cathode electrode may be made of an electrically conductive ceramic, such as strontium doped lanthanum manganite (LSM) or a noble metal such as platinum, which can be mixed with an oxygen ion conductor such as YSZ. Other materials capable of conducting electrons in an oxidizing environment can also be used.

If desired, the SOFCs may operate on the ground to produce quiet clean power, but in flight they switch to a highly efficient oxygen generator. In other words, when the aircraft is on the ground, air and fuel are provided to the solid oxide fuel cells to generate power for the aircraft. When the aircraft is in the air, the fuel is not provided to the SOFCs, and power (i.e., a voltage) is provided to the SOFCs to generate oxygen from ambient air.

Alternatively, the SOFCs may be operated to provide power to the aircraft on the ground and in flight. However, in case of emergency or failure, such as aircraft depressurization or malfunction of the air recycling or purification systems, the SOFCs switch to generating oxygen for metabolic use. In this case, the SOFCs may be switched manually by the pilot or automatically by a failure or depressurization detection sensor mechanism.

Alternatively, some but not all SOFCs switch from the power generation mode to the oxygen generation mode when the aircraft is in flight. For example, all SOFCs may operate in the power generation mode on the ground. However, in flight, some SOFCs are operated to provide power while other SOFCs are operated to provide oxygen. In this case, one or more SOFC stacks can be operated in the power generation mode while the remaining stack or stacks can be operated in the oxygen generation mode. Alternatively, one or more stacks may be dedicated to always operating in the power generation mode while another one or more stacks may be dedicated to always operating in the oxygen generation mode. In this case, the fuel cells that are dedicated to operating only in the power generation mode may contain non-reversible electrode materials, such as a Ni-YSZ anode cermet.

The SOFC mode of operation is controlled manually or automatically through control electronics, such as the cockpit control electronics 109 that are operated by the pilot, or by a computer or other general or dedicated logic device.

It should be noted that the aircraft 101 of the second embodiment may also contain the optional water transport 13 and heat transport 17 conduits described above with respect to the first embodiment. Furthermore, as described above, the aircraft may contain the distributed fuel cells of the first embodiment in combination with the oxygen generation mode of the second embodiment.

U.S. Pat. No. 6,854,688 is incorporated by reference herein in its entirety. The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings are not necessarily to scale and illustrate the device in schematic block format. The drawings and description of the preferred embodiments were chosen in order to explain the principles of the invention and its practical application, and are not meant to be limiting on the scope of the claims. It is intended that the scope of the invention be defined by the claims appended hereto, and their equivalents.

We claim:

1. An aircraft comprising a plurality of solid oxide fuel cells located in different portions of the aircraft.

2. The aircraft of claim 1, wherein the aircraft comprises a passenger airplane with a cabin.

3. The aircraft of claim 1, wherein a first solid oxide fuel cell is located in a front part of the aircraft and a second solid oxide fuel cell is located in a rear part of the aircraft.

4. The aircraft of claim 3, wherein a third solid oxide fuel cell is located in a middle part of the aircraft.

5. The aircraft of claim 1, wherein the solid oxide fuel cells are distributed throughout the aircraft.

6. The aircraft of claim 1, wherein the plurality of solid oxide fuel cells are arranged in a plurality of solid oxide fuel cell stacks which are distributed throughout the aircraft.

7. The aircraft of claim 2, further comprising a first means for operating the plurality of solid oxide fuel cells to generate oxygen for the aircraft cabin when the aircraft is in flight by providing ambient air and power to the solid oxide fuel cells without providing fuel to the solid oxide fuel cells.

8. The aircraft of claim 2, further comprising a water transport conduit which is configured to provide water from the solid oxide fuel cells to the aircraft cabin.

9. An aircraft, comprising:
an aircraft cabin;
at least one solid oxide fuel cell; and
a first means for operating the solid oxide fuel cell to generate oxygen for the cabin when the aircraft is in flight by providing ambient air and power to the solid oxide fuel cell without providing fuel to the solid oxide fuel cell.

10. The aircraft of claim 9, wherein:
a plurality of solid oxide fuel cells located are in different portions of the aircraft; and
the aircraft comprises a passenger airplane.

11. The aircraft of claim 9, further comprising a water transport conduit which is configured to provide water from the solid oxide fuel cell to the cabin.

12. The aircraft of claim 9, wherein the solid oxide fuel cell contains reversible electrodes.

13. A method of operating at least one first solid oxide fuel cell located in an aircraft, comprising providing ambient air and power to the first solid oxide fuel cell without providing fuel to the first solid oxide fuel cell to generate oxygen for aircraft cabin when the aircraft is in flight.

14. The method of claim 13, further comprising providing air and fuel to the first solid oxide fuel cell to generate power for the aircraft when the aircraft is on the ground.

15. The method of claim 14, further comprising providing water from the first solid oxide fuel cell to the aircraft cabin while the aircraft is on the ground.

16. The method of claim 13, further comprising:
providing air and fuel to a second solid oxide fuel cell to generate power for the aircraft when the aircraft is in flight; and
providing water from the second solid oxide fuel cell to the aircraft cabin while the aircraft is in flight.

17. The method of claim 13, wherein:
a plurality of solid oxide fuel cells located are in different portions of the aircraft; and
the aircraft comprises a passenger airplane.

18. The method of claim 13, wherein the first solid oxide fuel cell contains reversible electrodes.

19. The method of claim 13, wherein the at least one first solid oxide fuel cell comprises a plurality of first solid oxide fuel cells which increase oxygen content in air provided for metabolic use to a range of about 22% to about 25%.

20. A method of operating at least one solid oxide fuel cell located in a passenger aircraft, comprising providing water from the solid oxide fuel cell to aircraft cabin.

21. A method of operating a plurality of solid oxide fuel cells, comprising:
providing an aircraft comprising the plurality of solid oxide fuel cells located in different portions of the aircraft and a plurality of power consuming components located in different portions of the aircraft; and
providing power from each of the plurality of solid oxide fuel cells to at least one of the plurality of power consuming components located in a same portion of the aircraft as the solid oxide fuel cell.

22. The method of claim 21, wherein:
the aircraft comprises a passenger airplane with a cabin;
the plurality of solid oxide fuel cells are arranged in a plurality of solid oxide fuel cell stacks which are distributed throughout the aircraft; and
each one of the plurality of the solid oxide fuel cell stacks provides power to at least one of the plurality of the power consuming components which is located adjacent to the respective solid oxide fuel cell stack.
